(19) United States
(12) Patent Application Publication
(10) Pub. No.: US 2026/0330713 A1
(43) Pub. Date: Oct. 22, 2026

(54) DISPLAY SYSTEM AND DISPLAY METHOD

(71) Applicant: TOYOTA JIDOSHA KABUSHIKI KAISHA, Toyota-shi (JP)

(72) Inventor: Kazuho SAEKI, Kawasaki-shi (JP)

(73) Assignee: TOYOTA JIDOSHA KABUSHIKI KAISHA, Toyota-shi (JP)

(21) Appl. No.: 19/530,919

(22) Filed: Feb. 5, 2026

(30) Foreign Application Priority Data
Apr. 22, 2025 (JP) 2025-070863

(51) Int. Cl. G06T 11/26

(52) U.S. Cl. CPC G06T 11/26

(57) ABSTRACT

A display system according to the present disclosure includes a feature amount acquisition unit, a graph display unit, a locus display unit, and a reconstructed data display unit. The feature amount acquisition unit acquires a plurality of feature amounts extracted from the analysis target data. The graph display unit displays a graph in which points representing analysis target data are plotted with a plurality of feature amounts as axes. The locus display unit displays a trajectory on a graph. The reconstructed data display unit sets a feature amount based on coordinates of one point located on the trajectory, and outputs and displays the reconstructed data of the analysis target data in accordance with the set feature amount.

### CROSS-REFERENCE TO RELATED APPLICATION

This application claims priority to Japanese Patent Application No. 2025-070863 filed on Apr. 22, 2025. The disclosure of the above-identified application, including the specification, drawings, and claims, is incorporated by reference herein in its entirety.

### BACKGROUND

### 1. Technical Field

The present disclosure relates to a display system and a display method.

### 2. Description of Related Art

Japanese Unexamined Patent Application Publication No. 2024-106786 (JP 2024-106786 A) describes an information processing device that extracts a principal component and a principal component value (principal component score) from measurement data of a material through principal component analysis (PCA).

When displaying the principal component values of each of a plurality of generated measurement data on a display screen, the information processing device described in JP 2024-106786 A displays each of the images representing the principal components of the measurement data in an oblique arrangement with respect to the horizontal direction or the vertical direction on the display screen.

The information processing device described in JP 2024-106786 A displays a graph in which principal component values of the measurement data are plotted at positions representing intersections of lines extending in the vertical direction from a first image and lines extending in the horizontal direction from a second image for each pair of the first image and the second image among the images representing the principal components of the measurement data.

### SUMMARY

When an attempt is made to interpret a feature amount represented by a principal component, it is necessary to understand what kind of feature of the measurement data is reflected in the extracted feature amount. However, it is difficult to intuitively understand what kind of feature of the measurement data is reflected in the feature amount output as a result of the analysis.

Therefore, the analysis system according to the related art involves an issue that the user cannot appropriately interpret the analysis result. JP 2024-106786 A does not describe a technique capable of addressing such an issue.

The present disclosure has been made to address such an issue, and has an object to provide a display system and a display method capable of allowing a user to more appropriately interpret a feature amount.

An aspect of the present disclosure provides a display system including a feature amount acquisition unit, a graph display unit, a locus display unit, and a reconstructed data display unit. The feature amount acquisition unit acquires a plurality of feature amounts extracted from analysis target data. The graph display unit displays a graph that has axes corresponding to the feature amounts and in which points representing the analysis target data are plotted. The locus display unit displays a locus on the graph. The reconstructed data display unit sets a feature amount based on coordinates of a single point located on the locus, and outputs and displays reconstructed data of the analysis target data according to the set feature amount.

In the display system according to the aspect of the present disclosure, the locus display unit may display a point image on the locus. The reconstructed data display unit may set the feature amount based on coordinates at which the point image is displayed, and output and display the reconstructed data of the analysis target data based on the set feature amount.

The display system according to the aspect of the present disclosure may further include a score image display unit that displays a score image that is an image indicating a magnitude of the feature amount. The score image indicating the magnitude of the feature amount that is used as an axis of the graph may be configured to change along with movement of the point image. The score image indicating the magnitude of the feature amount that is not used as an axis of the graph may be configured to change according to a user operation on the score image. The reconstructed data display unit may set the feature amount based on the magnitude of the feature amount indicated by the score image, and output and display the reconstructed data of the analysis target data based on the set feature amount.

In the display system according to the aspect of the present disclosure, the score image indicating the magnitude of the feature amount that is used as an axis of the graph may be configured not to change according to a user operation on the score image.

In a display method according to an aspect of the present disclosure, a plurality of feature amounts extracted from analysis target data is acquired. A graph that has axes corresponding to the feature amounts and in which points representing the analysis target data are plotted is displayed. A locus is displayed on the graph. A feature amount is set based on coordinates of a single point located on the locus. Reconstructed data of the analysis target data are output and displayed according to the set feature amount.

According to the present disclosure, it is possible to provide a display system and a display method capable of allowing a user to more appropriately interpret a feature amount.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a configuration of an analysis system according to a first embodiment;

FIG. 2 is a block diagram illustrating a configuration of a server according to the first embodiment;

FIG. 3 is a block diagram illustrating a configuration of a server according to the first embodiment;

FIG. 4 is a schematic diagram for describing the configuration of the display control unit according to the first embodiment; and

FIG. 5 is a flowchart illustrating an operation of the display system according to the first embodiment.

### DETAILED DESCRIPTION OF EMBODIMENTS

### First Embodiment

### Configuring the Display System

Hereinafter, a first embodiment according to the present disclosure will be described in detail with reference to the drawings. First, the configuration of the display system according to the present embodiment will be described in detail.

The display system according to the present embodiment is configured as a part of the analysis system according to the present embodiment. More specifically, the display system according to the present embodiment is used to display an analysis result of the analysis system according to the present embodiment to a user.

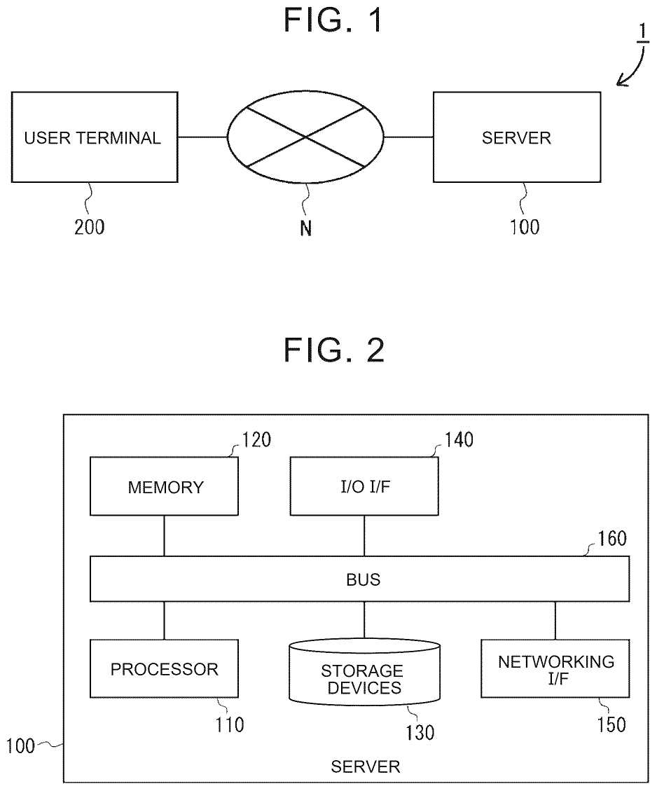

FIG. 1 is a block diagram illustrating a configuration of an analysis system according to a first embodiment. As illustrated in FIG. 1, the analysis system 1 according to the present embodiment is connected to a server 100 and a user terminal 200 via a network N such as the Internet.

The analysis system 1 is a system for analyzing measurement data and physical property value data obtained by actually measuring a sample. The analysis system 1 according to the present embodiment is typically provided as a part of a data cloud type service used in material development and research and development, and is used as a so-called material informatics (MI, Materials Informatics) or a system for promoting research and development using data science.

In the analysis system 1, the user terminal 200 transmits analysis target data to be analyzed to the server 100, and the server 100 analyzes the received analysis target data. Then, the server 100 transmits the analysis result to the user terminal 200, and displays the analysis result received by the user terminal 200 to the user.

Examples of the analysis target data analyzed by the analysis system 1 include spectral data, waveform data, graph data, secondary image data, and three-dimensional image data.

Examples of the spectral data include spectral data measured using nuclear magnetic resonance spectroscopy (NMR, Nuclear Magnetic Resonance spectroscopy), infrared spectroscopy (IR, InfraRed spectroscopy), ultraviolet-visible spectroscopy (UV-vis, Ultra Violet-Visible spectroscopy), X-ray absorptiometry (XAS, X-ray Absorption Spectroscopy), Raman spectroscopy, X-ray diffractometry (XRD, X-ray diffraction), X-ray small-angle scattering (SAXS, Small Angle X-ray Scattering), and mass-spectroscopy (MS, Mass Spectrometry).
Examples of the two-dimensional image data include image data captured using an optical microscope, a scanning electron microscope (SEM, Scanning Electron Microscope), a transmission electron microscope (TEM, Transmission Electron Microscope), and computed tomography (CT, Computed tomography).
Examples of the three-dimensional image data include image data generated by stacking tomograms captured by computed tomography (CT), model data generated by CAD (Computer-Aided design), and the like.
Examples of the wave system data include time series data and displacement data. Examples of the time-series data include acoustic data, vibration data, and the like, but any data whose numerical value changes with time can be taken as a target. The displacement data includes, for example, a surface height of a sample, a surface profile, and the like, and any data whose numerical value changes with changes in coordinates and other parameters can be taken as an object.
Further, examples of other data include cyclic voltammograms and gas chromatography (GC, Gas Chromatography) charts.
Further, as the data to be analyzed, for example, coordinate data such as a CIF (Crystallographic Information) file or numerical data such as a composition-component table can be used.

The user terminal 200 according to the present embodiment is a terminal operated by a user, and is typically a computer device having a display device.

The user terminal 200 transmits the analysis target to the server 100 via the network N. Then, the user terminal 200 receives the analysis result of the analysis target data from the server 100 via the network N.

The server 100 according to the present embodiment receives an analysis target from the user terminal 200 and analyzes the received analysis target. Then, the server 100 transmits the analysis result to the user terminal 200 via the network N.

FIG. 2 is a block diagram illustrating a configuration of a server according to the first embodiment.

As illustrated in FIG. 2, the server 100 includes a processor 110, a memory 120, a storage device 130, an input/output interface 140, a network interface 150, and an internal bus 160.

The internal bus 160 is a data transmission path through which the processor 110, the memory 120, the storage device 130, the input/output interface 140, and the network interface 150 transmit and receive data to and from each other. However, the method of connecting the processors 110 and the like to each other is not limited to the bus connection.

The memory 120 is a main storage device realized by using RAM (Random Access Memory).

The storage device 130 is an auxiliary storage device realized by using a hard disk, a SSD (Solid State Drive), a memory card, a ROM (Read Only Memory), or the like. The storage device 130 stores a program for realizing a desired function.

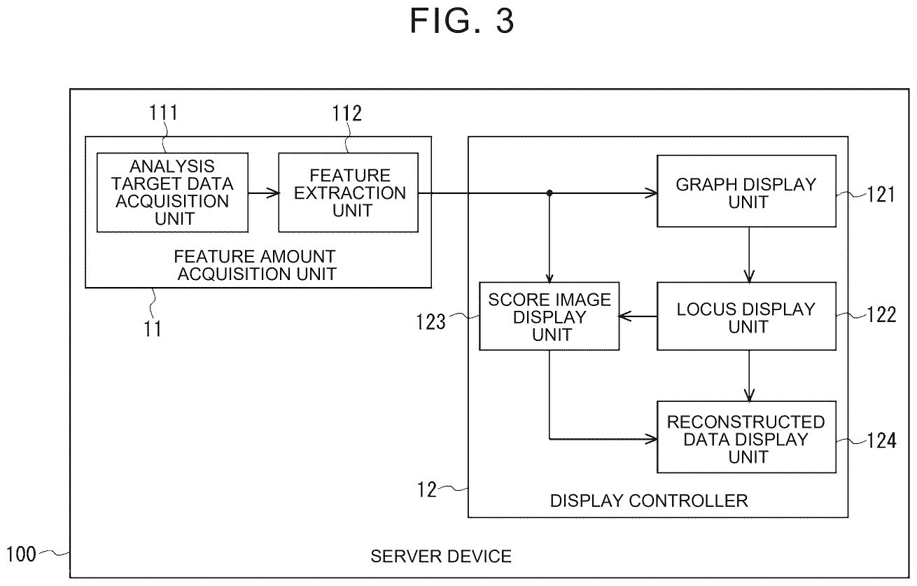

The processor 110 is a variety of processors, such as CPU (Central Processing Unit), GPU (Graphics Processing Unit), or FPGA (field-programmable gate array). The processor 110 reads a program stored in the storage device 130 into the memory 120 and executes the program, thereby executing a function as each functional block illustrated in FIG. 3 to be described later.

The input/output interface 140 is an interface for connecting the server 100 and the input/output device. For example, an input device such as a keyboard or an output device such as a display device may be connected to the input/output interface 140. The network interface 150 is an interface for connecting the server 100 to a network.

It should be noted that the program includes instructions (or software code) for causing a computer to perform one or more of the functions described in the embodiments when loaded into the computer. The program may be stored in a non-transitory computer-readable medium or a tangible storage medium. By way of example, and not limitation, computer-readable media or tangible storage media include RAM, ROM, flash memory, SSD, or other memory techniques. Computer-readable media or tangible storage media also include CD-ROM, DVD (digital versatile disc), Blu-ray, or other optical disk storage, magnetic cassettes, magnetic tape, magnetic disk storage, or other magnetic storage devices. The program may be transmitted on a transitory computer readable medium or a communication medium. By way of example, and not limitation, transitory computer-readable media or communication media include electrical, optical, acoustic, or other forms of propagated signals.

FIG. 3 is a block diagram illustrating a configuration of a server according to the first embodiment. As illustrated in FIG. 3, the server 100 according to the present embodiment includes the feature amount acquisition unit 11 and the display control unit 12 as functional blocks.

The feature amount acquisition unit 11 acquires a plurality of feature amounts extracted from the analysis target data. The feature amount acquisition unit 11 outputs the acquired feature amount to the display control unit 12.

For example, the feature amount acquisition unit 11 may acquire the feature amount by reading the feature amount stored in the storage device 130 in response to a designation from the user.

Further, the feature amount acquisition unit 11 may acquire the feature amount by acquiring the analysis target data and extracting the feature amount from the acquired analysis target data. In this case, the feature amount acquisition unit 11 includes an analysis target data acquisition unit 111 and a feature amount extraction unit 112 as illustrated in FIG. 3.

Although details will be described later, the feature quantity acquired by the feature amount acquisition unit 11 according to the present embodiment is plotted on the graph data. Therefore, it is preferable that the feature quantity acquired by the feature amount acquisition unit 11 according to the present embodiment is acquired as numerical data.

Specific examples of the feature amount acquired by the feature amount acquisition unit 11 include, for example, a principal component value (Principle Component Score) corresponding to the principal component (Principle Component) extracted by the principal component analysis (PCA, Principle Component Analysis).

The analysis target data acquisition unit 111 acquires a plurality of analysis target data. More specifically, the analysis target data acquisition unit 111 according to the present embodiment acquires a plurality of analysis target data from the user terminal 200 via the network N. The analysis target data acquisition unit 111 outputs the acquired plurality of analysis target data to the feature amount extraction unit 112.

Note that the analysis target data acquisition unit 111 according to the present embodiment does not need to acquire a plurality of analysis target data by one reception. For example, the analysis target data acquisition unit 111 according to the present embodiment may acquire a plurality of pieces of analysis target data by acquiring the analysis target data in a plurality of times.

In this case, the analysis target data acquisition unit 111 may store the acquired analysis target data in the storage device 130 every time the analysis target data is acquired. Then, the feature amount extraction unit 112 may appropriately read the analysis target data to be analyzed from the storage device 130.

That is, the analysis target data acquisition unit 111 may create a database in which analysis target data is recorded. The created database may be configured such that the user can appropriately select analysis target data to be analyzed.

The feature amount extraction unit 112 acquires a plurality of pieces of analysis target data from the analysis target data acquisition unit 111. The feature amount extraction unit 112 extracts feature amounts from the plurality of acquired analysis target data. The feature amount extraction unit 112 outputs the extracted feature quantity to the display control unit 12.

For example, the feature amount extraction unit 112 according to the present embodiment performs principal component analysis (PCA, Principle Component Analysis) on a plurality of pieces of analysis target data, thereby acquiring a principal component (Principal component) and a principal component value (Principal component score) as feature quantities. Principal components and principal component values obtained by principal component analysis are particularly difficult for a user to intuitively understand among results obtained by analysis using feature amounts. Therefore, the display system according to the present disclosure has a special effect when the principal component value is used as the feature amount.

However, the feature amount extracted from the analysis target data by the feature amount extraction unit 112 is not limited to the principal component and the principal component value. The feature amount extracted from the analysis target data by the feature amount extraction unit 112 may be any feature amount as long as it can be extracted as a numerical value.

The display control unit 12 acquires the feature amount from the feature amount acquisition unit 11. The display control unit 12 controls the display screen of the user terminal 200 based on the acquired feature amount, and displays the analysis result. The display control unit 12 according to the present embodiment includes a graph display unit 121, a locus display unit 122, a score image display unit 123, and a reconstructed data display unit 124.

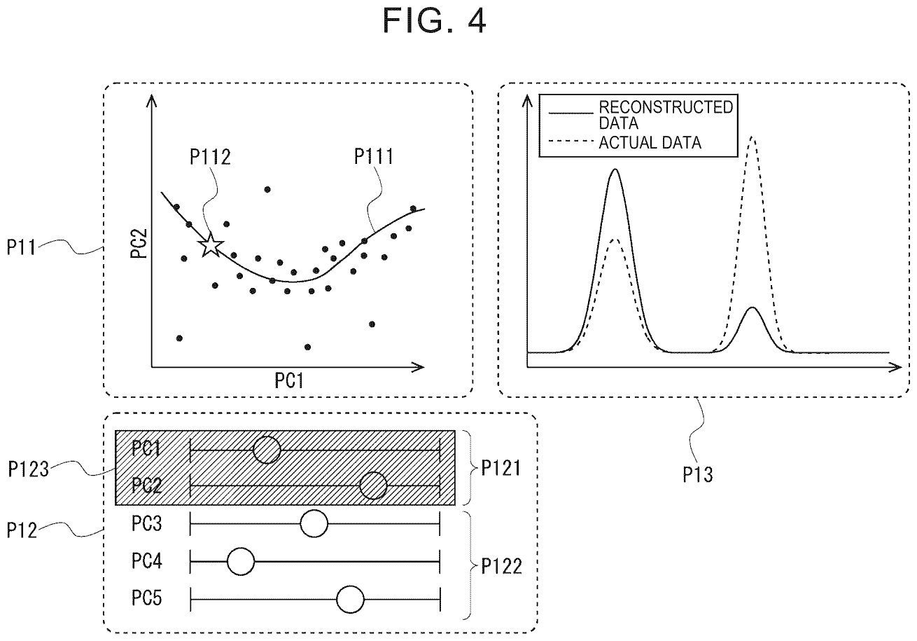

FIG. 4 is a schematic screen diagram for explaining a configuration of a display control unit according to the first embodiment; More specifically, FIG. 4 is a diagram illustrating a specific example of a screen displayed on the display screen of the user terminal 200 by the display control unit 12 according to the first embodiment. Hereinafter, the configuration of the display control unit 12 according to the present embodiment will be described in more detail with reference to FIGS. 3 and 4.

The graph display unit 121 acquires the feature amount from the feature amount acquisition unit 11. The graph display unit 121 according to the present embodiment displays a graph in which points representing analysis target data are plotted with a plurality of feature amounts as axes.

More specifically, for example, the graph display unit 121 according to the present embodiment causes the user terminal 200 to display a graph as illustrated in the graph P11 illustrated in FIG. 4.

Specifically, the graph P11 is a graph in which the value of the feature amount represented by the name of “PC1” is taken on the horizontal axis of the graph, and the value of the feature amount represented by the name of “PC2” is taken on the vertical axis of the graph. In the graph P11, points representing a plurality of samples are plotted.
With such a configuration, the display system according to the present embodiment can allow the user to intuitively grasp the correlation between the plurality of feature amounts. Note that the graph P11 according to the present embodiment is a two-dimensional graph, but the graph according to the present disclosure may be, for example, a three-dimensional graph.

The locus display unit 122 displays a trajectory on a graph.

More specifically, the locus display unit 122 according to the present embodiment displays the locus P111 so as to overlap with the graph P11 shown in FIG. 4.
More specifically, the locus display unit 122 may output a straight line or a curve passing through the vicinity of each plotted point based on the distribution of the points representing the samples plotted in the graph P11, and display the output straight line or curve as the locus P111.
That is, the locus display unit 122 according to the present embodiment may display, as the locus P111, a regression line, an approximate curve, or both of the samples plotted in the graph P11.
With such a configuration, the display system according to the present embodiment can allow the user to grasp the correlation between the plurality of feature amounts in detail.

Note that the locus P111 displayed by the locus display unit 122 is not limited to a regression line and an approximate curve, and may be, for example, a line defined by a user.

The locus P111 displayed by the locus display unit 122 may be any locus as long as the locus indicates the correlation of the feature quantities used as the axis of the chart.

Further, the locus display unit 122 according to the present embodiment displays the point image P112 on the trajectory. Note that the point image P112 is configured to be able to move on the locus P111 in response to a user manipulation. As will be described later, the coordinates represented by the point image P112 according to the present embodiment are used for displaying the score image P12 and the reconstructed data P13, which will be described later.

The score image display unit 123 displays a score image that is an image indicating the size of the feature amount. That is, the score image display unit 123 according to the present embodiment displays the score image P12 as shown in FIG. 4 on the display window of the user terminal 200.

As illustrated in FIG. 4, the score image display unit 123 according to the present embodiment displays, as the score image P12, an image in which the size of the feature quantity is displayed as a bar.

However, the score image according to the present disclosure is not limited to the above-described image, and may be, for example, a text image in which the size of the feature amount is expressed by a numerical value. The score image may be any image as long as it is an image capable of allowing the user to grasp the size of the feature amount.

Here, the score image P12 illustrated in FIG. 4 includes a score image P121 representing the size of the feature amount used as the axis of the graph, and a score image P122 representing the size of the feature amount not used as the axis of the graph. Specifically, the score image P12 illustrated in FIG. 4 includes score image P121 which is an image representing the sizes of “PC1” and “PC2” which are feature amounts used as the axes of the graph P11. In addition, the score image P12 illustrated in FIG. 4 includes score image P122 which is an image representing the sizes of “PC3”, “PC4”, and “PC5”, which are feature amounts not used as the axes of the graph P11.

Here, the score image indicating the size of the feature quantity used as the axis of the graph, i.e., the score image P121 in FIG. 4, is configured to change as the point image P112 moves. In other words, the score image P121 in the present embodiment represents the values of “PC1” and “PC2” corresponding to the position of the point image P112.

In addition, the score image indicating the size of the feature quantity not used as the axis of the graph, that is, the score image P122 in FIG. 4 is configured to change in accordance with the user's manipulation on the score image.

In other words, in the present embodiment, the user can specify the features “PC3”, “PC4”, and “PC5” by executing an editing operation on the score image P122.
As will be described later, P13 of the feature values specified by the user's manipulation on the score image P122 is used for outputting the reconstructed data.

In addition, the score image indicating the size of the feature quantity used as the axis of the graph, that is, the score image P121 in FIG. 4 may be configured not to change in accordance with the user's manipulation with respect to the score image. That is, in the present embodiment, the score image P121 in FIG. 4 may be configured to change only by changing the position of the point image P112.

As illustrated in FIG. 4, the score image display unit 123 may superimpose and display a score image indicating a size of a feature quantity used as an axis of the graph, that is, a blind image on the score image P121.

According to such a configuration, the user can easily determine which of the plurality of displayed score images is a score image corresponding to the feature amount used as the axis of the graph. In addition, according to this configuration, the user can intuitively recognize that the user cannot operate the score image P121.

The reconstructed data display unit 124 sets a feature amount on the basis of coordinates of one point located on the trajectory, and outputs and displays the reconstructed data of the analysis target data according to the set feature amount.

More specifically, the reconstructed data display unit 124 according to the present embodiment sets the feature amount based on the coordinates where the point image P112 is displayed, and outputs and displays the reconstructed data of the analysis target data based on the set feature amount.

Further, the reconstructed data display unit 124 sets the feature amount based on the size of the feature amount indicated by the score image P12, and outputs and displays the reconstructed data of the analysis target data based on the set feature amount.

That is, the reconstructed data display unit 124 according to the present embodiment acquires the value of the position coordinates of the point image P112 as the value of the feature quantity used as the axis of the graph.

In other words, the reconstructed data display unit 124 according to the present embodiment receives the change in the setting of the feature value used as the axis of the graph by manipulating the position of the point image P112.
More specifically, in the present embodiment, the reconstructed data display unit 124 sets the coordinates of the abscissa of the point image P112 as the feature quantity “PC1”. Further, in the present embodiment, the reconstructed data display unit 124 sets the coordinates of the vertical axis of the point image P112 as the feature quantity “PC2”.

Further, the reconstructed data display unit 124 according to the present embodiment acquires the value represented in the score image P12 as the value of the feature quantity.

More specifically, the reconstructed data display unit 124 according to the present embodiment acquires, based on the score image P12, the feature values that are not used as the axis of the graph.
In other words, the reconstructed data display unit 124 according to the present embodiment receives a change in setting of a feature value that is not used as an axis of a graph by an editing operation of the user with respect to the score image P12.
More specifically, in the present embodiment, the reconstructed data display unit 124 sets the values represented by the score image P122 as the values of the feature amounts “PC3”, “PC4”, and “PC5”, respectively.

Then, the reconstructed data display unit 124 outputs the reconstructed data P13 based on the set feature amounts, and displays the reconstructed data on the display screen of the user terminal 200.

Here, the reconstructed data is data obtained by simulating analysis target data having a set feature amount. That is, the reconstructed data is virtual analysis target data having a feature amount set by the user or the analysis system 1.

For example, when the acquired feature amount is a principal component value, the reconstructed data display unit 124 acquires the principal component corresponding to the acquired principal component value. Then, the reconstructed data display unit 124 may calculate the vector D^{rec} according to Equation (1) below, and convert the calculated vector D^{rec} to output the reconstructed data.

D^{rec}=S₁v₁+S₂v₂+. . . +Sₙvₙ expression (1)

### However,

Sₖ is the principal component value of the k-th component set by the user or the analysis system 1,
vₖ is a vector representing the principal component of the k-th component.

For example, the reconstructed data display unit 124 according to the present embodiment can output the reconstructed data, which is virtual analysis target data having the set feature amount, by the above-described method.

As illustrated in FIG. 4, the reconstructed data display unit 124 according to the present embodiment may superimpose and display the reconstructed data that is virtual analysis target data and the actual measurement data that is actual analysis target data. According to such a configuration, the user can intuitively grasp the validity of the reconstructed data.

Here, the reconstructed data display unit 124 according to the present embodiment may display the reconstructed data while continuously changing the position of the point image P112 in accordance with the user's manipulation.

According to such a configuration, the user can more intuitively grasp the influence of the feature amount used as the graph axis on the analysis target data.

Further, the reconstructed data display unit 124 according to the present embodiment may display the reconstructed data while continuously changing the reconstructed data in accordance with a change in the value represented by the score image P122 by the user's manipulation.

According to such a configuration, the user can more intuitively grasp the influence of the feature amount not used as the graph axis on the analysis target data.

As described above, the analysis system 1 according to the present embodiment is configured to display a trajectory on a graph plotting points representing analysis target data with a plurality of feature amounts as axes. Then, the feature amount is set based on the coordinates of one point located on the trajectory, and the reconstructed data of the analysis target data is output and displayed according to the set feature amount.

According to such a configuration, the display system according to the present embodiment can display the simulation data of the analysis target data having the virtual feature amount while reflecting the correlation between the plurality of feature amounts. As a result, the display system according to the present embodiment can cause the user to interpret the feature amount more appropriately.

### Operation of the Display System

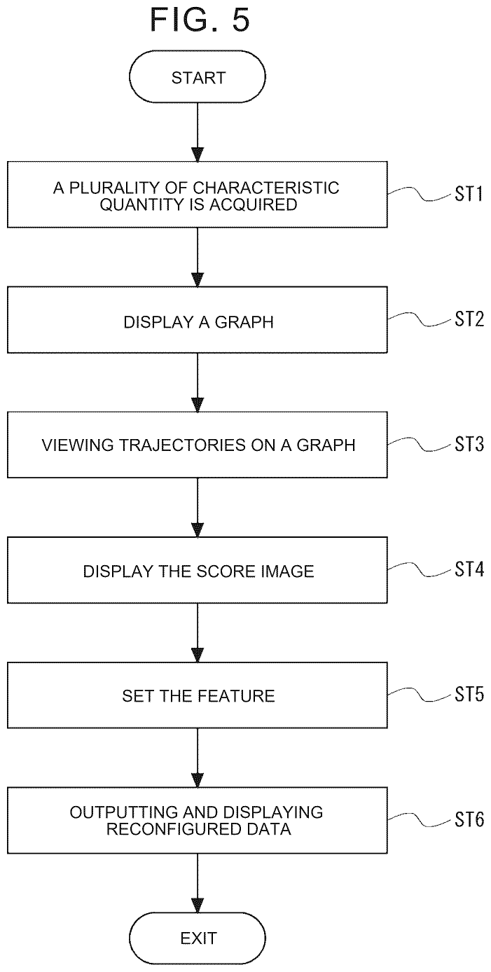

Next, the operation of the display system, that is, the display method according to the first embodiment will be described in detail. FIG. 5 is a flowchart illustrating an operation of the display system according to the first embodiment. In the following description, reference is made to FIGS. 1 to 4 as appropriate.

In the processing procedure of FIG. 5, the processor 110 reads the program stored in the storage device 130 into the memory 120 and executes the program, thereby functioning as the feature amount acquisition unit 11 and the display control unit 12.

In the display method according to the present embodiment, first, the processor 110 acquires a plurality of features (ST1). More specifically, in ST1, the processor 110 acquires a plurality of features extracted from the object to be analyzed. That is, in ST1, the processor 110 functions as the feature amount acquisition unit 11.

In ST1, the processor 110 may obtain features from a data base recorded on the storage device 130. In addition, in ST1, the processor 110 may acquire a plurality of pieces of analysis target data and extract a feature amount from the acquired analysis target data, thereby acquiring the feature amount.

The processor 110 then ST2 the chart. More specifically, in ST2, the processor 110 displays a graph in which a plurality of feature amounts are taken as axes and points representing the analysis target data are plotted. That is, in ST2, the processor 110 functions as the graph display unit 121.

Specifically, in ST2, the processor 110 causes the graph P11 in FIG. 4 described above to be displayed on the display screen of the user terminal 200.

The processor 110 then ST3 the trajectory on the chart. That is, in ST3, the processor 110 functions as the locus display unit 122.

More specifically, in ST3, the processor 110 causes the locus P111 in FIG. 4 described above to be displayed on the display screen of the user terminal 200.
Further, in ST3, the processor 110 causes the above-described point image P112 in FIG. 4 to be displayed on the display screen of the user terminal 200.

The processor 110 then ST4 the scoring images. More specifically, in ST4, the processor 110 displays a scoring image that is an image indicating the size of the feature quantity. That is, in ST3, the processor 110 functions as the score image display unit 123. More specifically, in ST4, the processor 110 causes the above-described score image P12 in FIG. 4 to be displayed on the display screen of the user terminal 200.

Next, the processor 110 ST5 the characteristic quantity. More specifically, in ST5, the processor 110 sets the feature values based on the coordinates of one point located on the trajectory. That is, in ST5, the processor 110 functions as the reconstructed data display unit 124.

More specifically, in ST5, the processor 110 sets the position coordinates on the graph on which the above-described point image P112 is displayed as the feature values used as the axis of the graph.
In addition, in ST5, the processor 110 sets the value of the feature amount indicated by the score image P122 edited by the user manipulation as the value of the feature amount that is not used as the axis of the graph.

Finally, the processor 110 outputs and ST6 the reconstructed data, and the display system according to the present embodiment terminates the series of operations. More specifically, in ST6, the processor 110 outputs and displays the reconstructed data of the analysis target data in accordance with the set feature quantity. That is, in ST6, the processor 110 functions as the reconstructed data display unit 124.

As described above, in the display method according to the present embodiment, a trajectory is displayed on a graph plotting points representing analysis target data with a plurality of feature amounts as axes. Then, the feature amount is set based on the coordinates of one point located on the trajectory, and the reconstructed data of the analysis target data is output and displayed according to the set feature amount. According to such a configuration, the display method according to the present embodiment can display the simulation data of the analysis target data having the virtual feature amount while reflecting the correlation between the plurality of feature amounts. As a result, the display method according to the present embodiment allows the user to interpret the feature amount more appropriately.

Although the present disclosure has been described with reference to the above embodiments, it is to be understood that the disclosure is not limited only to the configuration of the above embodiments, but also includes various modifications, modifications, and combinations that may be made by a person skilled in the art within the scope of the claims of the present application.

What is claimed is:

1. A display system comprising:
a feature amount acquisition unit that acquires a plurality of feature amounts extracted from analysis target data;
a graph display unit that displays a graph that has axes corresponding to the feature amounts and in which points representing the analysis target data are plotted;
a locus display unit that displays a locus on the graph; and
a reconstructed data display unit that sets a feature amount based on coordinates of a single point located on the locus, and outputs and displays reconstructed data of the analysis target data according to the set feature amount.

2. The display system according to claim 1, wherein:
the locus display unit displays a point image on the locus; and
the reconstructed data display unit sets the feature amount based on coordinates at which the point image is displayed, and outputs and displays the reconstructed data of the analysis target data based on the set feature amount.

3. The display system according to claim 2, further comprising
a score image display unit that displays a score image that is an image indicating a magnitude of the feature amount, wherein:
the score image indicating the magnitude of the feature amount that is used as an axis of the graph is configured to change along with movement of the point image;
the score image indicating the magnitude of the feature amount that is not used as an axis of the graph is configured to change according to a user operation on the score image; and
the reconstructed data display unit sets the feature amount based on the magnitude of the feature amount indicated by the score image, and outputs and displays the reconstructed data of the analysis target data based on the set feature amount.

4. The display system according to claim 3, wherein the score image indicating the magnitude of the feature amount that is used as an axis of the graph is configured not to change according to a user operation on the score image.

5. A display method comprising:
acquiring a plurality of feature amounts extracted from analysis target data;
displaying a graph that has axes corresponding to the feature amounts and in which points representing the analysis target data are plotted;
displaying a locus on the graph;
setting a feature amount based on coordinates of a single point located on the locus; and
outputting and displaying reconstructed data of the analysis target data according to the set feature amount.
